(19) United States
(12) Patent Application Publication
(10) Pub. No.: US 2010/0010188 A1
(43) Pub. Date: Jan. 14, 2010

(54) METHOD OF POLYMERIZING SILICONE FLUID

(75) Inventor: Bimal Pillai, Navi Mumbai (IN)

Correspondence Address: ARENT FOX LLP, 1050 CONNECTICUT AVENUE, N.W., SUITE 400, WASHINGTON, DC, 20036, US

(73) Assignee: NOUVEAW EXPORTS PRIVATE LIMITED, Vikhroli-West, Mumbai, Maharashtra (IN)

(21) Appl. No.: 12/281,226

(22) PCT Filed: Feb. 27, 2007
(86) PCT No.: PCT/IB07/00464

§ 371 Date: May 19, 2009

(30) Foreign Application Priority Data
Mar. 1, 2006 (IN) 296/MUM/2006

(51) Int. Cl. C08G 77/08

(52) U.S. Cl. 528/23

(57) ABSTRACT

The present invention relates to an improved method of polymerizing silicon fluids, more particularly, this method is particularly convenient for producing low viscosity silicone oils.

### FIELD OF INVENTION

The present invention relates to an improved method of polymerising silicone fluid. More particularly, the present invention relates to preparation of low viscosity silicone oil by mixing or adding a catalyst into mixture of siloxanes & (optionally) terminators at ambient temperatures or at higher temperatures.

### BACKGROUND OF INVENTION

Siloxanes are a class of organosilicon compounds with the empirical formula R₂SiO, where R is an organic group. Representative examples are [SiO(CH₃)₂]ₙ (dimethylsiloxane) and [SiO(C₆H₅)₂]ₙ (diphenylsiloxane), where n is typically >4. These compounds can be viewed as a hybrid of both organic and inorganic chemical compounds. The organic side chains confer hydrophobic properties while the —Si—O—Si—O— backbone is purely inorganic. The word siloxane is derived from the words Silicon, Oxygen, and alkane. Siloxanes can be found in products such as cosmetics, deodorant, water repelling windshield coatings, and some soaps. They occur in landfill gas and are being evaluated as alternatives to perchloroethylene for drycleaning. Perchloroethylene is widely considered environmentally undesirable.

It is known that Silicone fluids are usually straight chains of poly (dimethylsiloxane), or PDMS, which are terminated with a trimethylsilyl group (or groups). PDMS fluids come in all viscosities—from water-like liquids to intractable fluids. All of these are essentially water insoluble. PDMS fluids may be further modified with the addition of organofunctional groups at any point in the polymer chain. Silicone gels are lightly cross-linked PDMS fluids, where the cross-link is introduced either through a trifunctional silane—such as CH₃SiCl₃ giving a “T-branched” silicone structure—or through a chemical reaction between a Si-vinyl group on one polymer chain with a hydrogen bonded to silicon in another. This chemical “tying” of siloxane chains produces a three-dimensional network that can be swollen with PDMS fluids to give a sticky, cohesive mass without form. Further, silicone elastomers are cross-linked fluids whose three-dimensional structure is much more intricate than a gel. In addition, there is very little free fluid in the matrix. Fillers, such as amorphous silica, are frequently added to the matrix to give greater reinforcement to the network and thereby increase the strength of the product.

Silicone resins are more heavily cross-linked polymer networks that are formed by the introduction of a predominance of tri- and tetra-functional monomers, such as CH₃SiCl₃ The physical properties of the finished silicone resin can be tailored to suit many applications by varying the ratio of branched and linear siloxanes and also the functional groups attached to the silicon.

It is known that silicone oil of various viscosities are manufactured by polymerization of low molecular weight polydimethylsiloxanes —((CH₃)₂Si—O)ₙ— in presence of chain terminators like Hexamethyldisiloxane (CH₃)₃Si—O—Si(CH₃)₃ or low molecular weight trimethylsiloxy terminated polydimethylsiloxanes (CH₃)₃Si—O—((CH₃)₂Si—O)ₙ—Si(CH₃)₃. The said polymerization is generally carried out by adding Potassium hydroxide (KOH) or other catalysts to siloxane & terminator mixtures and then heating to high temperatures generally (90° C. to 150° C.).

Further more siloxanes containing Si—H linkage during polymerization form branching/cross-linking in the chain, which render the whole polymer insoluble. The said process is can also be accompanied by the liberation of hydrogen, which can be a hazard. It is known that methylhydrogen chlorosilanes can be hydrolyzed and condensed to obtain silicone fluids retaining a high proportion of reactive hydrogen, but typically they contain 1% or more of branch sites. The reactions are often difficult to control, and the results are erratic (i) sometimes producing useless gels or hard brittle solids instead of fluids, and (ii) hydroxyl substitution on silicon (.tbd.SiOH) which leads to gelation. This limits the usefulness of methylhydrogen siloxanes as starting materials for polymer synthesis.

According, to very commonly used procedure polydimethylsiloxanes —((CH₃)₂Si—O)ₙ—, (wherein more than 50% of molecules have n equal to 4 and 5] generally of viscosity 2 to 5 CP, are mixed with chain terminators (hexamethyldisiloxane/Trimethylsiloxy terminated dimethyldisiloxane) and KOH. Then the mixture is heated up 150° C. and maintained for time period of up to 5 hours. Then the said mixture is neutralized, filtered and then heated under vacuum to obtain non-volatile Silicone Oil. The disadvantages of the said process are:
KOH being immiscible in the siloxane.
The polymerization being carried out at 150° C., hence it is difficult to use Hexamethyldisiloxane (HMDSO) as a chain terminator because it has boiling point of ˜100° C. and tends to vaporize at the polymerization temperatures.
The said problem is even more acute when trying to make PDMS of molecular weight less than 1250, wherein more than 10% of HMDSO is required to be added into the siloxane mixture for polymerization.
Heating the silicone mass mixture involves usage of energy.

According to US patent documents U.S. Pat. No. 6,344,533 B1 and U.S. Pat. No. 6,284,859 B1 in polymerization processes catalysts such as toluene sulphonic acid, sulphuric acid, phosphoric acid, trifluoromethanesulphonic acid, trifluoroacetic acid, aluminiumsulphatedihydrate, phosphonitrilic chlorides, ionic phosphazene acid catalysts, which are solid under conditions, such as acid activated bleaching earth, acid zeolites, sulphonated charcoal and others have been used. However, these processes have some disadvantages.
While making silicone oil of less than 50 CP viscosity, if sulfuric acid is used as catalyst the mixing has to be very vigorous to keep the insoluble acid layer from separating out.
Also, the said reaction being carried out up to 100° C., the suitable material for construction of such reactor, which can withstand up to 100° C. with acid catalysts is also expensive.
Other catalysts can introduce a non-silicone compound into the silicone mixture, for example in the case of toluenesulfonic acid, toluene is introduced into the silicone mixture, and toluene being soluble in silicone oil, hence this has to be separated by distillation.

Solid catalysts are generally suitable only for low viscous polymerisations, as these have to be finally separated by filtration. Also the mixing has to be good to ensure adequate contact with the insoluble catalyst.

The above-said disadvantages have been overcome in the present invention. In the present invention linear or straight chain polysiloxanes can be prepared with very less or no undesired branched-chain polysiloxanes or gels.

### OBJECTIVES OF INVENTION

1. The primary objective of the present invention is to provide an improved method to polymerize siloxanes with least branching.

2. Yet another objective of the present invention is to provide a method of polymerising silicones fluid of low viscosity and/or higher viscosity.

3. Yet another objective of the present invention is to provide a method of polymerization silicones fluid of low viscosity of 1 & 1.5 cP.

4. Yet another objective of the present invention is to provide a method of polymerization of high concentration of low molecular weight straight chain siloxanes.

5. Yet another objective of the present invention is to polymerize polyorganosiloxanes.

### SUMMARY OF INVENTION

The present invention relates to a method of polymerising silicone fluid, wherein SO₃ is used in catalytic quantity 2 ppm to 200000 ppm or 0.00020% to 20% by weight and mixed with siloxanes & chain terminator siloxanes. Preferably the SO₃ concentration is between 500 ppm to 50000 ppm. Then a reaction time of 15 minutes to 24 hours is allowed for the mixture. The reaction time is even less than 15 minutes depending on the quantity of catalyst added and final viscosities desired. The reaction is carried out at elevated temperatures or more preferably at room temperatures. After the reaction is over (close to equilibrium) the oil is neutralized, then optionally
a) filtered and then heated under vacuum to obtain non-volatile silicone oil (in case of high viscous silicone).
b) Distilled in case of low viscous oil.
c) or any other treatment as desired by a person skilled in the art.

### DETAILED DESCRIPTION OF INVENTION

Accordingly, the present invention relates to an improved method of polymerising silicone fluids comprising the step of mixing one or more catalyst with silicones or siloxanes and optionally heated, to effect rearrangement of chain length of silicone molecules, wherein the catalyst is selected from the group comprising
Sulfurtrioxide (SO₃) or
SO₃ mixed with HMDSO to form Bis(trimethylsilyl) sulfate, or
Bis(trimethylsilyl) sulfate or
Sulfurtrioxide containing siloxane or SO₃ & H₂SO₄ mixed with HMDSO or any siloxane oleum or
Oleum mixed with HMDSO to form Bis(trimethylsilyl) sulfate, or
Oleum containing siloxane or
Oleum & H₂SO₄ mixed with HMDSO or any siloxane

One aspect of the invention is to provide a method wherein the amount of catalyst is in the range of 500 ppm to 50000 ppm.

One another aspect of the invention is to provide a method wherein the siloxane molecules is polydialkylsiloxanes

Yet another aspect of the invention is to provide a method wherein the siloxane molecules is polyalkylhydrogensiloxanes

Still another aspect of the invention is to provide a method wherein the siloxane is Octamethylcyclotetrasiloxane.

One more aspect of the invention is to provide a method wherein the siloxane molecules thus prepared are polyalkylhydrogensiloxanes.

Yet another aspect of the invention is to provide a method wherein the siloxane molecules thus prepared are polydialkylsiloxanes.

Yet another aspect of the present invention, wherein catalyst and siloxanes are mixed in order to obtain products, which are not branched-chain polysiloxanes or gels, but linear or straight chain polysiloxanes. Especially in the case of polymethyhydrogensiloxanes, hydrogen terminated siloxanes & organofunctionalpolysiloxanes.

Yet one another aspect of the present invention is to provide a process provides a way for rearrangement of Si—O—Si linkage in siloxanes which helps to produce various viscosities/molecular weight Organo functional siloxanes, as other than the Si—O—Si linkage which gets rearranged, there are other Si—X bonds which gets least affected during the polymerisation process. Where the X can be Carbon or halogen or hydrogen radical.

Yet another embodiment of the present invention, wherein SO₃ is mixed with Hexamethyldisiloxane and other siloxanes is used instead of SO₃ as such.

Adding SO₃ having disadvantage that it is difficult to handle a catalyst. Therefore, sometimes, SO₃ mixed with HMDSO to form Bis(trimethylsilyl) sulfate to use as a catalyst.

Alternatively, a mixture of siloxanes, HMDSO and SO₃ (preferably SO₃ 20% to 35%) may be used.

Or a mixture of siloxanes, other siloxane chain terminators and SO₃ (preferably SO₃ 20% to 35%) may be used.

Or a mixture of siloxanes, H₂SO₄ (preferably 1 to 2%) and SO₃ (preferably SO₃ 20% to 35%) may be used

Or a mixture of siloxanes and Oleum may be used

SO₃ containing sulfonating compounds like oleum can also be used in place of SO₃ in all the above combinations for preparation of catalyst, although SO₃ is the preferred compound.

Then this Bis(trimethylsilyl) sulfate can be added as chain terminator either in combination with other chain terminators or by itself into polydimethylsiloxanes to obtain silicone oil of desired viscosity.

These catalysts being stable can be prepared or procured and stored easily for use in polymerisation. For the polymerization of silicones containing Si—H functionality SO₃ in siloxane mixtures is a preferred catalyst.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention.

### EXAMPLE—1

A siloxane mixture of 1000 gm Octamethylcyclotetrasiloxane mixed with 12 gm Hexamethyldisiloxane. Evaporation loss test of feed material indicated 100% evaporation loss. The viscosity of the mixture was ˜2 cP. SO₃ vapours are passed over the above-mentioned mixture. The mixture is left for 24 hours then the mixture is neutralized with NaOH. The viscosity of the mixture was now ˜200 cP. Evaporation loss test of sample indicated ˜12% evaporation loss. This indicates that the molecular weights of siloxane molecules have increased. Evaporation loss test: Keep 1 gm sample in a 60 mm diameter glass Petri dish. Keep this dish in an oven for 45 minutes. The oven is maintained at 150° C.

### EXAMPLE—2

A siloxane mixture of 1000 gm Octamethylcyclotetrasiloxane mixed with 9 gm Hexamethyldisiloxane. Evaporation loss test of feed material indicated 100% evaporation loss. The viscosity of the mixture was ˜2 cP Bis(trimethylsilyl) sulfate is added to the above mixture. The mixture is left for 24 hours then the mixture is neutralized with NaOH. The viscosity of the mixture was now ˜200 cP. Evaporation loss test of Oil produced, showed ˜12% evaporation loss, which indicates that molecular weights of siloxane molecules have increased. and viscosity is achieved. Evaporation test: Keep 1 gm sample in a 60 mm diameter glass Petri dish. Keep this dish in an oven for 45 minutes. The oven is maintained at 150° C.

### EXAMPLE—3

SO₃ is added to 50 gm Hexamethyldisiloxane. Then part of this mixture is added to 1000 gm Octamethylcyclotetrasiloxane mixed with Hexamethyldisiloxane. The viscosity of the mixture was ˜2 cP. The mixture is left as is for 24 hours then the mixture is washed with water and neutralized with aqueous NaOH. The viscosity of the mixture was now ˜200 cP. Evaporation loss test of Oil produced, showed ˜12% evaporation loss, which indicates that molecular weights and viscosity of siloxane molecules have increased. Evaporation test: Keep 1 gm sample in a 60 mm diameter glass Petri dish. Keep this dish in an oven for 45 minutes. The oven is maintained at 150° C.

### EXAMPLE—4

200 gm Bis(trimethylsilyl) sulfate is added to mixture of 1000 gm Octamethylcyclotetrasiloxane. The viscosity of the mixture was ˜2 cP. The mixture is left as is for 4 hours. Then the mixture is washed with water and neutralized with aqueous NaOH. The viscosity of the mixture was now ˜5 cP. Evaporation loss test of Oil produced, showed 33% evaporation loss, which indicates that molecular weights of siloxane molecules have increased and viscosity is achieved. Evaporation test: Keep 5 gm sample in a 50 ml glass beaker. Keep this beaker in an oven for 60 minutes. The oven is maintained at 150° C.

### EXAMPLE—5

1000 gm volatile siloxane mixture obtained from cracking 500 CP viscosity trimethyl terminated silicone oil is taken. Evaporation loss test of sample indicated 100% evaporation loss. 100 gm of this volatile siloxane mixture is mixed with 80 gm HMDSO & 60 gm SO₃ 900 gm of remaining volatile siloxane mixture is mixed with 10 gm of the above mixture containing SO₃. The viscosity of the mixture was ˜2 cP. The mixture is left as is for 24 hours then the mixture is neutralized with Na-silanolate. The viscosity of the mixture was now ˜300 cP. Evaporation loss test of sample, showed 12% evaporation loss. This indicates that the molecular weights of siloxane molecules have increased.

### EXAMPLE—6

SO₃ is added to 50 gm Hexamethyldisiloxane. Then part of this mixture is added to 1000 gm mixture of hexamethyldisiloxane & Methylhydrogenpolysiloxane cylics. The viscosity of the mixture was ˜2 cP. The mixture is left as is for 24 hours then the mixture is washed with water and neutralized with water washes. The viscosity of the mixture was now ˜10 cP. Evaporation loss test of Oil produced, showed ˜12% evaporation loss, which indicates that molecular weights and viscosity of siloxane molecules have increased. Evaporation test: Keep 1 gm sample in a 60 mm diameter glass Petri dish. Keep this dish in an oven for 20 minutes. The oven is maintained at 150° C.

### EXAMPLE—7

SO₃ is added to 50 gm Hexamethyldisiloxane. Then part of this mixture is added to 1000 gm Octamethylcyclotetrasiloxane mixed with Hexamethyldisiloxane. The viscosity of the mixture was ˜2 cP. The mixture is left as is for 24 hours then the mixture is washed with water and neutralized with aqueous NaOH. Then the Gas chromatography analysis of the mixture showed Octamethylcyclotetrasiloxane less than ˜1%, and >50% of molecules having 3 to 6 Silicon atoms in their structure. Hence producing high concentration of low molecular siloxanes.

In each example, SO₃ is used either directly or indirectly as a polymerisation catalyst.

### Advantages of the Invention

1. SO₃, Bis(trimethylsilyl) sulfate & other siloxane SO₃ mixtures are miscible in silicone oil so the polymerization proceeds with ease.

2. The reaction takes place even at ambient temperatures this leads to energy savings & even the material of construction restrictions ease, as many plastics are also suitable at ambient temperatures.

3. Particularly convenient for low molecular weight silicone fluids.

4. Particularly convenient making high concentrations of low molecular weight siloxanes having 3 or 4 silicon in the molecules.

5. Particularly convenient for silicone fluids having Si—H linkages.

6. No impurity is introduced. In this process SO₃ used is neutralized and then the salt is separated by filtration or by washing or can even be left in the mixture. The carrier siloxanes if at all used is selected from the siloxanes similar to those that are to be polymerized so these do not bring any unwanted impurity into the silicone polymerizations.

7. Since polymerisation can be done at room temperatures there is energy savings.

1. An improved method of polymerizing silicone fluids comprising the step of mixing one or more catalysts at ambient condition with silicones or siloxanes and optionally heating, to effect rearrangement of chain length of silicone molecules, wherein the catalyst is selected from the group consisting of:
Sulfurtrioxide (SO₃),
SO₃ mixed with HMDSO to form Bis(trimethylsilyl) sulfate,
Bis(trimethylsilyl) sulfate,
Sulfurtrioxide containing siloxane,
SO₃ and H₂SO₄ mixed with HMDSO or any siloxane, oleum,
Oleum mixed with HMDSO to form Bis(trimethylsilyl) sulfate,
Oleum containing siloxane, and
Oleum and H₂SO₄ mixed with HMDSO or any siloxane.

2. The method as claimed in claim 1, wherein the amount of catalyst is in the range of 500 ppm to 50000 ppm.

3. The method as claimed in claim 1, wherein the siloxane molecules are polydialkylsiloxanes.

4. The method as claimed in claim 1, wherein the siloxane molecules are polyalkylhydrogensiloxanes.

5. The method as claimed in claim 1, wherein the siloxane is Octamethylcyclotetrasiloxane.

6. The method as claimed in claim 1, wherein the siloxane molecules thus prepared are polyalkylhydrogensiloxanes.

7. The method as claimed in claim 1, wherein the siloxane molecules thus prepared are polydialkylsiloxanes.
